(19) United States
(12) Patent Application Publication
(10) Pub. No.: US 2008/0091838 A1
(43) Pub. Date: Apr. 17, 2008

(54) Multi-level congestion control for large scale video conferences

(76) Inventor: Sean Miceli, Sunnyvale, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/549,043

(22) Filed: Oct. 12, 2006

(51) Int. Cl. G06F 15/16

(52) U.S. Cl. 709/231

(57) ABSTRACT

A method for streaming data is described. In the method, a pair of timing packets is periodically transmitted to a client, the second packet of the pair being transmitted after the first packet with a known delay. A plurality of reports are received from the client, each of the reports including a Δt value representative of the length of time that elapsed between receipt by the client of the first packet and the second packet of the pairs of timing packets. Additional bandwidth is determined to be available when the Δt values decrease. A new data stream having a higher bitrate is selected for transmission to the client when additional bandwidth is determined to be available. A server for streaming data is also described.

### CROSS REFERENCE TO RELATED APPLICATIONS

This application is related to U.S. patent application Ser. No. 10/192,130 filed on Jul. 10, 2002 and entitled “Method and Apparatus for Controllable Conference Content via Back-Channel Video Interface;” U.S. patent application Ser. No. 10/192,080 filed on Jul. 10, 2002 and entitled “Multi-Participant Conference System with Controllable Content Delivery Using a Client Monitor Back-Channel;” U.S. patent application Ser. No. 11/051,674 filed on Feb. 4, 2005 and entitled “Adaptive Bit-Rate Adjustment of Multimedia Communications Channels Using Transport Control Protocol;” U.S. patent application Ser. No. 11/199,600 filed on Aug. 9, 2005 and entitled “Client-Server Interface to Push Messages to the Client Browser;” U.S. patent application Ser. No. 11/340,062 filed on Jan. 25, 2006 and entitled “IMX Session Control and Authentication;” and U.S. patent application Ser. No. 11/457,285 filed on Jul. 13, 2006 and entitled “Large Scale Real-Time Presentation of A Network Conference Having a Plurality Of Conference Participants;” all of which are incorporated herein by reference.

### BACKGROUND

Conferencing systems are used to facilitate communication between two or more participants physically located at separate locations. Systems are available to exchange live video, audio, and other data to view, hear, or otherwise collaborate with each participant. Common applications for conferencing include meetings/workgroups, presentations, and training/education. Today, with the help of video conferencing software, a personal computer with an inexpensive camera and microphone can be used to connect with other conferencing participants. Peer-to-peer video conferencing software applications allow each participant to see, hear, and interact another participant and can be inexpensively purchased separately. Motivated by the availability of software and inexpensive camera/microphone devices, video conferencing has become increasingly popular.

Video communication relies on sufficiently fast networks to accommodate the high information content of moving images. Audio and video data communication demand increased bandwidth as the number of participants and the size of the data exchange increase. Even with compression technologies and limitations in content size, bandwidth restrictions severely limit the number of conference participants that can readily interact with each other in a multi-party conference.

Video streaming technology is available that allows for a single audio/video source be viewed by many people. This has lead to conferencing systems referred to as “one to many systems” that enable a single presenter to speak to many passive viewers. In a one-to-many conference, the “one” is typically denoted as a speaker or presenter, and the “many” are an attending “audience” or viewers. A primarily unidirectional exchange, the one-to-many conference requires all audience members to be able to hear and see the activities of the speaker (i.e., the speaker's media is transmitted to all participants).

In conferencing systems, as well as in certain other applications of data streaming technology, it is important to provide the highest quality data stream possible. Generally, higher-quality data streams provide better fidelity to the original signal. A high quality video data stream, for instance, will provide a video image that is visually indistinguishable from an original feed direct from the video camera, whereas a lower quality video data stream may appear choppy or pixilated, or contain other artifacts of high ratio compression. Higher quality data streams tend to require higher data throughput, and therefore are often referred to as “high bitrate data stream” vs. a “low bitrate data stream.” Because streaming clients are often limited as to the available bandwidth with which to receive a data stream, and because streaming clients may have limited processing power necessary to decode a high quality data stream, it is important that the bitrate of the data stream sent to the streaming client be optimized such that it uses as much of the available bandwidth or processing power as possible to provide the end user with the highest quality user experience available over the particular connection and with the particular hardware being used.

In existing streaming servers, users are typically asked to select a suitable bitrate for their system. For example, they may be asked to select between “cable” “DSL” and “dial-up,” each of which refers to a particular quality of streaming data. In other systems, the connection is tested and the bitrate is automatically selected for the user. However, these systems are incapable of changing the data stream from a high bitrate to a low bitrate or vice versa on the fly once streaming has begun and as the bandwidth requirements or conditions change. Furthermore, they do not generally account for the processing capacity of the client to process the data stream. For example, a high bitrate video stream may take significant processing power to decode and display on the user's monitor. Even if there is plenty of bandwidth available to download the high bitrate video, the user would still not be able to view it in real time.

A real time data streaming technology that is capable of optimizing a bitrate being transmitted to each streaming client of a large number of streaming clients and reacts to bandwidth requirements as well as individual changes in bandwidth availability is required.

### SUMMARY

Broadly speaking, the present invention fills these needs by providing a multi-level congestion control for large-scale video conferences.

It should be appreciated that the present invention can be implemented in numerous ways, including as a process, an apparatus, a system, a device, or a method. Several inventive embodiments of the present invention are described below.

In one embodiment, a method for streaming data is provided. In the method, a pair of timing packets is periodically transmitted to a client, the second packet of the pair being transmitted after the first packet with a known delay. A plurality of reports are received from the client, each of the reports including a Δt value representative of the length of time that elapsed between receipt by the client of the first packet and the second packet of the pairs of timing packets. Additional bandwidth is determined to be available when the Δt values decrease. A new data stream having a higher bitrate is selected for transmission to the client when additional bandwidth is determined to be available.

In another embodiment a server for streaming data is provided. The server includes a media codec configured to receive a high bitrate data stream and generate at least one lower bitrate data stream. The high bitrate data stream and each of the lower bitrate data streams represent media content. The server also includes a packetizer and a transmit circuit. The packetizer is configured to encapsulate the high bitrate data stream and each of the lower bitrate data streams into network packets. The transmit circuit is configured to transmit one of the data streams in the form of the network packets to a client. The server further includes a receive circuit and a controller. The receive circuit is configured to receive communications from the client. The controller is configured to cause the transmit circuit to periodically transmit a pair of timing packets to the client. Each of the pair of timing packets includes a first packet and a second packet, the second packet being transmitted after the first packet with a known delay. The controller is further configured to receive a report from the client in response to each pair of timing packets, each of the reports including a Δt value representative of the length of time that elapsed between receipt of the first packet and receipt of the second packet by the client of a corresponding one of the pairs of timing packets. The controller being further configured to determine that additional bandwidth is available when the Δt values decrease, and cause the transmit circuit to transmit a higher bitrate data stream to the client than the client is currently receiving when the additional bandwidth is determined to be available.

In yet another embodiment a method for adjusting a bitrate of streaming data being transmitted to is provided. In the method, one of a plurality of data stream is transmitted to the client in the form of a plurality of data packets. Each data stream contains streaming data representing a multimedia signal at a different bitrate. The number of unprocessed ones of the data packets is monitored. When the number of unprocessed data packets increases, the bitrate of the data stream is reduced. In addition, a determination as to whether additional bandwidth is available is made. When the number of unprocessed data packets reduces and the additional bandwidth is available, the bitrate of the data stream is increased.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 shows an exemplary “few to many” conferencing system having a plurality of conference participants and a plurality of streaming clients.

FIG. 2 shows an exemplary computer suitable for use with the conferencing system of FIG. 1.

FIG. 3 is another view of the conferencing system of FIG. 1.

FIG. 4 shows a flowchart depicting an exemplary procedure for identifying a receivable bandwidth for a streaming clients.

FIG. 5 shows a flowchart illustrating a procedure for determining whether the number of packets have been transmitted but unprocessed by the client has increased or decreased.

FIG. 6 shows an exemplary transaction between a data streaming server and a streaming clients according to the method of FIG. 5.

FIG. 7 shows an exemplary graph that illustrates an exemplary operation of flowchart of FIG. 5.

FIG. 8 shows a flowchart illustrating a procedure for measuring a relative measurement of network bandwidth using inter-frame packet timings.

FIG. 9 shows an exemplary transaction between a data streaming server and a streaming clients.

### DETAILED DESCRIPTION

In the following description, numerous specific details are set forth in order to provide a thorough understanding of the present invention. However, it will be apparent to one skilled in the art that the present invention may be practiced without some of these specific details. In other instances, well known process operations and implementation details have not been described in detail in order to avoid unnecessarily obscuring the invention.

FIG. 1 shows an exemplary “few to many” conferencing system 100 having a plurality of conference participants 130 and a plurality of streaming clients 150. Conference participants 130 access conferencing server 110 to participate in a panel discussion, collaboration, or other event. A conference participant is used herein to identify a person that is a collaborator, speaker, or presenter. The conference participant may freely interject and interact with other conference participants. In one embodiment, each conference participant 130 can contribute to the discussion by providing real-time high bit-rate video and audio data and/or other multimedia content such as images, application sharing, documents, and annotations, which any other conference participant can then receive. Each conference participant can interject into a conversation with his or her own contribution without having to first get permission from a moderator. Thus, a conference participant is a person who is permitted to freely engage in a conversation with one or more other conference participants.

Streaming clients 150 access data streaming server (DSS) 120 to receive audio, video, and other multimedia content such as images, documents, and annotations in real time. Any media can be transmitted using DSS 120 provided it can be encoded in a plurality of bitrates. In one embodiment, DSS 120 may receive audio, video, and other multimedia content directly from conferencing server 110 via a local area network (LAN) connection 146. Streaming clients 150 generally will be able to receive a combined audio stream made up of audio streams from all conference participants 130. However, in one embodiment, each streaming client 150 can only view one high audio/video stream from one of the conference participants 130, or a composite video stream formed from a plurality of video streams, and generally cannot choose which conference participant 130 to view. Furthermore, streaming clients may be given an opportunity to ask questions by sending a signal along reverse path 157 to DSS 120 indicating a desire to ask a question, and then, after permission is granted, a low bit-rate video and/or audio signal can be sent from the streaming clients to DSS 120 encoding the individual's question.

To select which video feed to send to streaming clients 150, and to permit question or feedback from streaming clients 150, a special conference participant, referred to herein as controller client 140, is provided with a control panel. Controller client 140 is connected to both conferencing server 110 and DSS 120. Using the control panel, controller client 140 can designate and communicate to conferencing server 110 which video stream from conference participants 130 to send to streaming clients 150. In addition, controller client 140 connects with DSS 120 to interact with streaming clients 150. Such interaction includes assistance with setting up, e.g., confirming their audio and video signals are being received, and selecting which audio and/or video feed from streaming clients 150 to send to conference participants 130 when asking a question. Other interactions are also possible, such as chatting. Chatting is the sending and receiving of instant text messages between participants. Additional details of conferencing system 100 are provided in related U.S. patent application Ser. No. 11/457,285, which is incorporated herein by reference.

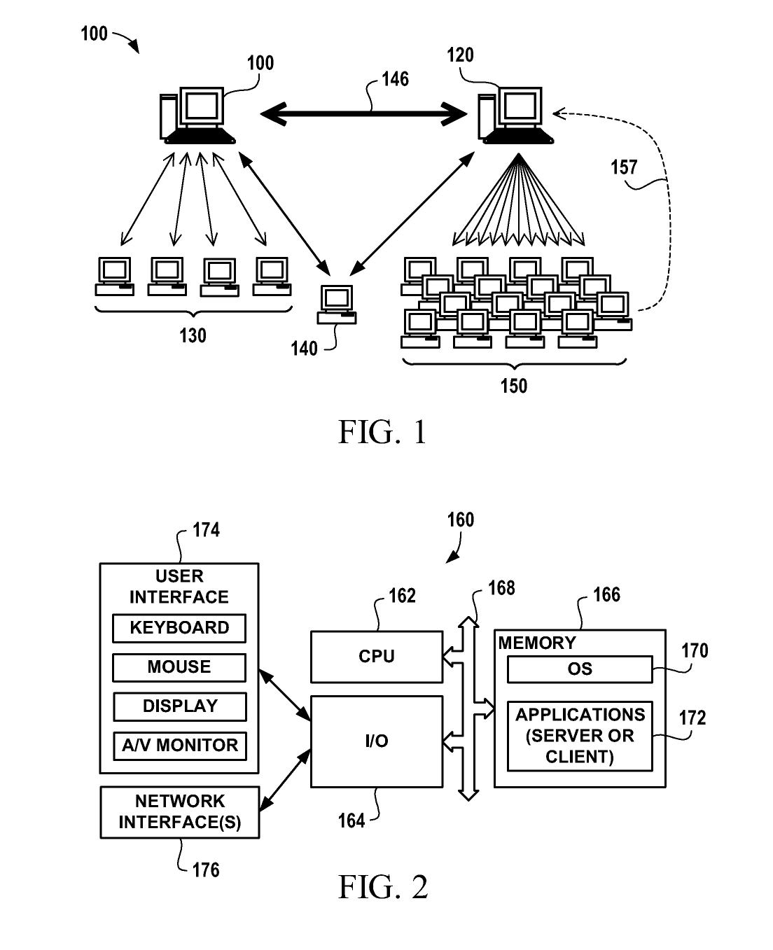

FIG. 2 shows an exemplary computer 160 having a CPU 162, input/output (I/O) ports 164, and a memory 166, which are in electronic communication via bus 168. Computer 160 is a general purpose computer system that may be used as DSS 120, a streaming client 150, or other computer system connected in conferencing system 100. Memory 166 includes an operating system 170 and applications 172. If computer 160 is a server, then applications 172 will include server software. If computer 160 is a client, then applications 172 will include client software. It is also possible that computer 160 act as both a server and a client, in which case, applications 172 will include server software as well as client software. Herein, the term, “server” will refer to a computer system that primarily acts as a server, and the term “client” will refer to a computer system that primarily acts as a client, although it should be understood that each can act in either capacity or both simultaneously, depending upon the software being run. Each server may serve multiple functions.

I/O ports 164 can be connected to external devices, including user interface 174 and network interface 176. User interface 174 may include user interface devices, such as a keyboard, video screen, and a pointing device such as a mouse. Network interface 176 may include one or more network interface cards (NICs) for communicating via an external network.

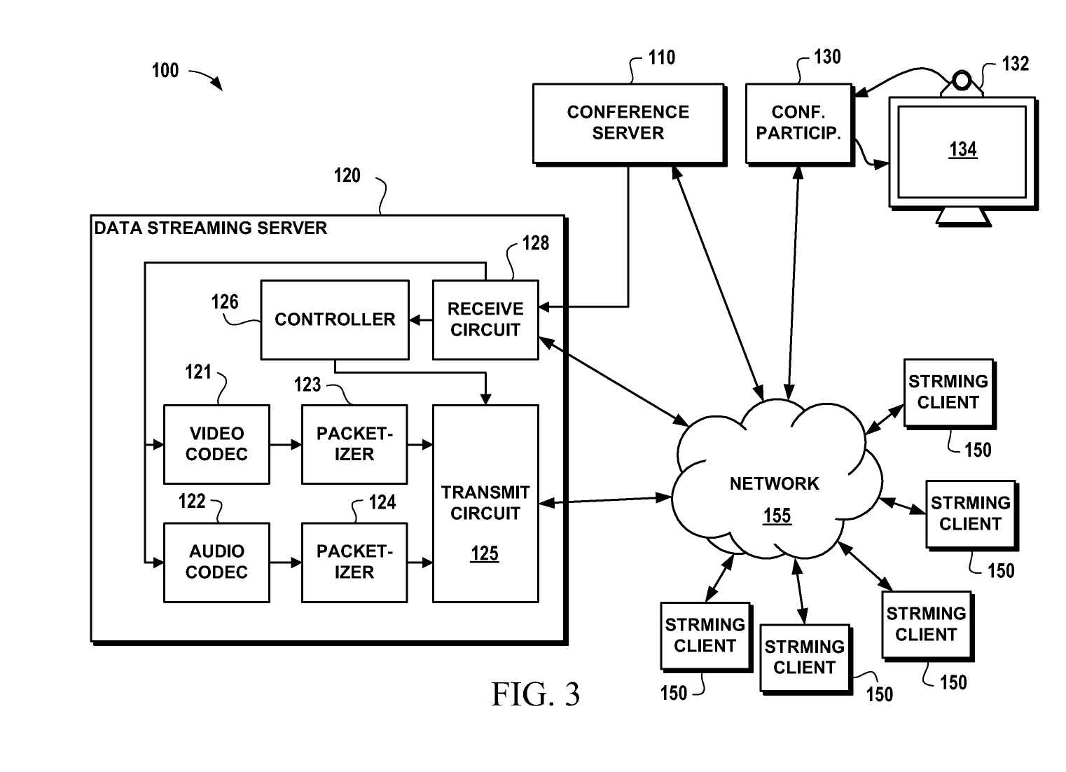

FIG. 3 is another view of the conferencing system 100 of FIG. 1 to better illustrate operation of DSS 120. Each of a number of conference participants 130 (only one shown) generates streaming audio and video data using audio/video monitor 130. Conference server 110 receives this streaming audio and video data by way of network 155, which may be a wide area network such as the Internet. The audio signals from each conference participant are mixed and retransmitted to other conference participants 130 as well as to DSS 120 in accordance with preferences selected by controller client 140 (see FIG. 1). In addition, the video signals from each conference participant may be selectively retransmitted to conference participants 130 for display on video displays 134. Alternatively, conference server 110 may composite a plurality of received video signals to generate a composite video signal incorporating a plurality of video signals, each having the corresponding image reduced in size to generate the composite video image. For example, the composite signal may combine four video streams by placing the video image of each video stream in a separate quadrant of the composite video image. In one embodiment, each conference participant 130 can select which video signals to include in the composite signal, and manipulate the layout so that some videos are larger than others. Thus, conference server 110 may receive each video signal, and depending on preferences selected by each participant, the conference server 110 may decode, composite, and then re-encode the new composite signal for each recipient. For the DSS, controller client 140 (FIG. 1) may select which video signals to include in the composite signal. The mixed audio and composite video signals transmitted to DSS may be transmitted over a network connection 146.

DSS 120 receives the mixed audio and composite video signal from conference server 110. The format of the audio and video signal may vary depending on the particular implementation. For example, the audio and video signals may be provided in a compressed format or an uncompressed format. In one embodiment, the audio and video signals are transmitted to DSS 120 as high quality, high bitrate compressed signals via network connection 146. The high quality compressed audio and video signals may be retransmitted by DSS 120 as they are received directly to one or more streaming clients 150 that are capable of receiving and processing high quality, high bitrate signals. For these recipients, the audio and video signals may pass through audio and video codecs 121, 122 to packetizers 123, 124, and to transmit circuit 125. It should be noted that codecs 121, 122, packetizers 123, 124, and transmit circuits 125 may each be implemented as hardware or software components of DSS 120. In one embodiment, codecs, packetizers and the transmit and receive circuits are all implemented as hardware components, which operate at the direction of a software server application.

Some of streaming clients 150 may not be capable of receiving high quality high bitrate audio and video signals, either because they lack sufficient network bandwidth to accommodate the signals, or because they lack sufficient available processor power to decode the high quality signals in real time. By “real time” it is meant that the incoming data can be processed as fast as it is received, without increasing lag times between receipt of data representing a specific frame of video, and actual display of that frame of video. For streaming clients that are not capable of receiving the high quality high bitrate audio and video signals, audio and video codecs 122, 121, decode the audio and video signals, respectively, and re-encode the signals at a higher compression, lower quality, lower bitrate signal.

Because there may be many, e.g., 40 or more, streaming clients, each with different available bandwidth and processing power, it may not be possible to finely tailor the bitrate to optimize content quality for each streaming client. Therefore, DSS 120 may transmit audio and video data in a predetermined number of bitrates. In one embodiment, DSS 120 retransmits the high-quality high bitrate audio and video signals received from conference server 110 and generates two lower quality, lower bitrate signals for one or more streaming clients 150 that cannot receive the high quality high bitrate signal. For example, a second data stream may be generated by codecs 121, 122 that is half the bitrate of the high bitrate signal, and a third data stream may be generated by codecs 121, 122 that is a fourth of the bitrate of the high bitrate data stream. The reduced bitrate data streams may be generated by using a higher compression algorithm, and/or by dropping or combining audio channels, and/or by dropping frames to reduce the refresh rate of a video. Receive circuit 128 receives communications from streaming clients 150 as will be described in further detail below and passes this communication to controller 126, which may be a hardware or software component of DSS 120 to identify, for each streaming client 150, which level of bitrate it is capable of receiving.

While DSS 120 is presented herein in the context of a video conferencing system, it should be recognized that it may be implemented in other ways. For example, for broadcasting over the Internet a live sporting event in real time.

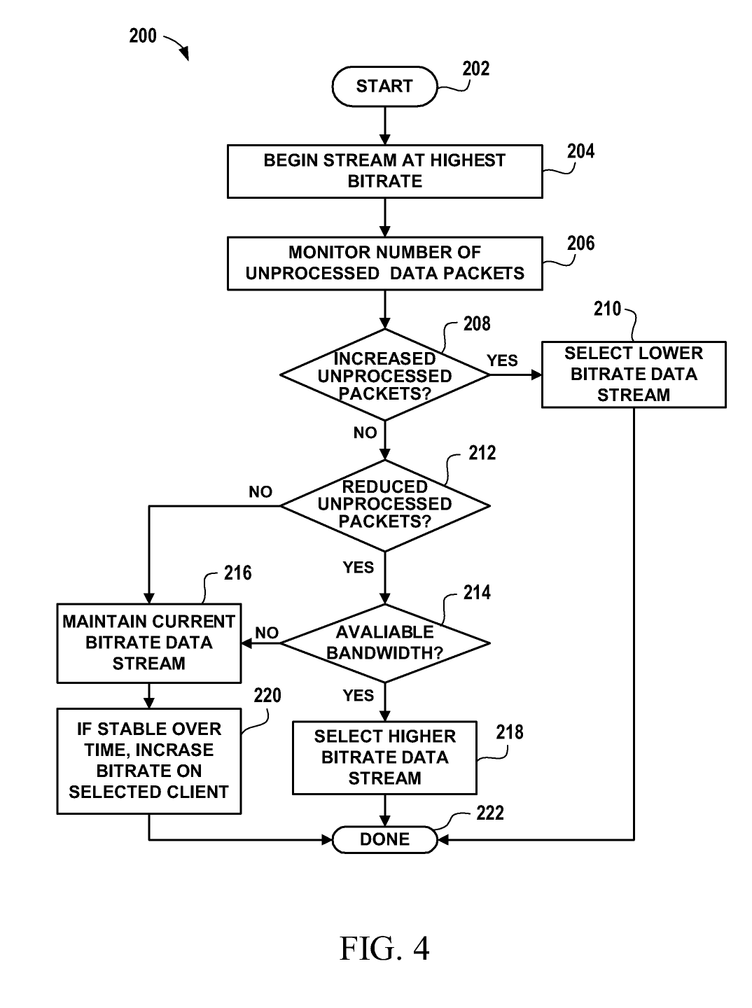

FIG. 4 shows a flowchart 200 depicting an exemplary procedure for identifying a receivable bandwidth for a particular one of streaming clients 150 (FIGS. 1, 3). The flowchart begins as indicated by start block 202 and proceeds to operation 204 wherein a data stream, which may include one or more of audio information and/or video information, is begun at a high bitrate.

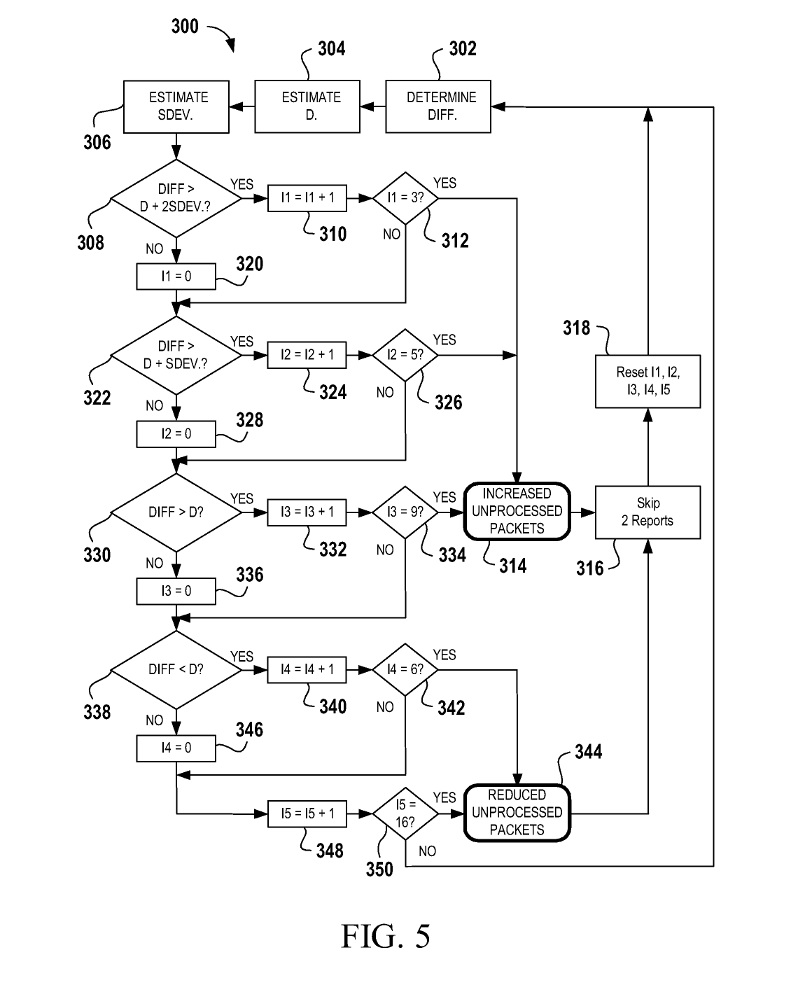

In operation 206, the DSS monitors the number of unprocessed data packets in a manner that is described in more detail below with reference to FIGS. 5-7. An unprocessed data packet is one that is either in transmission from DSS 120 to a streaming client 150, or has been received by the streaming client 150, but has not yet been processed, e.g., verified and presented to the user. In operation 208, DSS 120 determines whether the number of unprocessed packets data packets has increased. If the number of unprocessed data packets has increased according to the algorithm described below with reference to FIGS. 5-7, then the procedure flows to operation 210 wherein a lower bitrate data stream is sent to the streaming client. After selecting a lower bitrate data stream, the procedure ends as indicated by done block 222. It should be noted that this procedure may be carried out repeatedly for each streaming client during the course of the data stream.

In operation 208, if the number of unprocessed packets has not increased, then the procedure flows to operation 212, to determine if the number of unprocessed packets has reduced. If the number of unprocessed packets has reduced according to the algorithm described below with reference to FIGS. 5-7, then the procedure flows to operation 214. If the number of unprocessed packets has not reduced, i.e., remained substantially the same, then the procedure flows to operation 216.

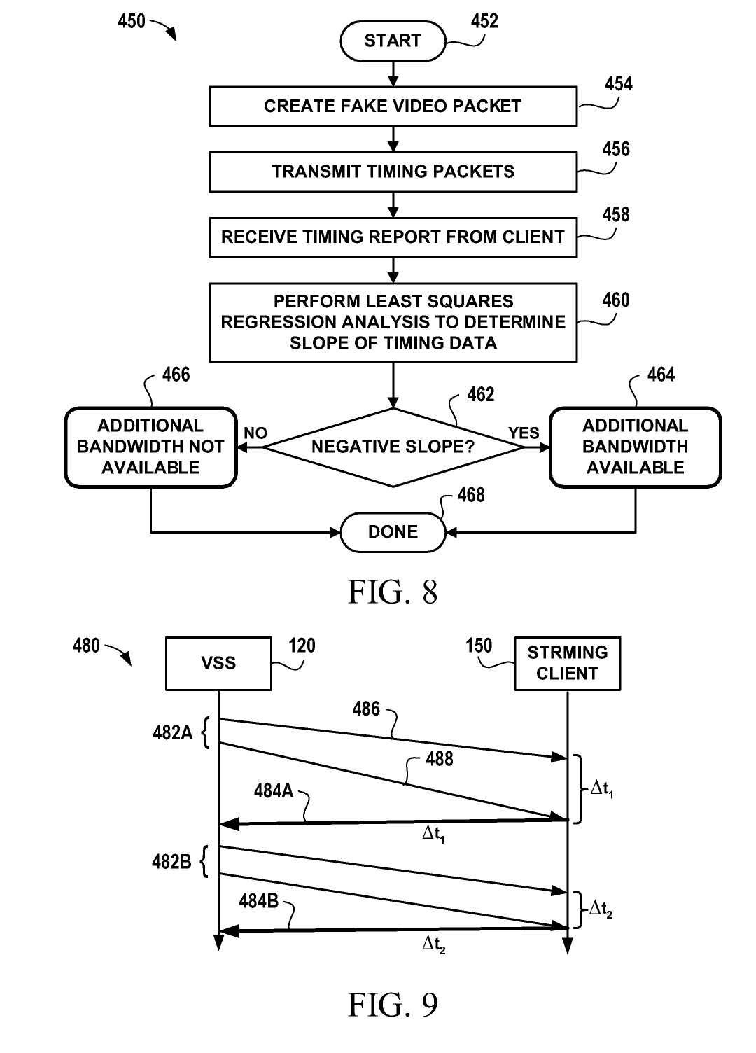

In operation 214, DSS 120 determines whether there is significant available bandwidth in the connection from the server to the streaming clients. The determination as to whether there is significant available bandwidth may be performed as described below with reference to FIGS. 8 and 9. If there is available bandwidth, then the procedure flows to operation 218, wherein an increased bitrate data stream is selected for transmission to the client. After selecting the increased bitrate data stream, the procedure ends as indicated by done block 222.

Operation 216 is performed when there is insufficient available bandwidth as determined in operation 214, or when the number of unprocessed packets is not reduced as determined in operation 212. In operation 216, the current data stream sent to the streaming clients is maintained. In operation 220, as will be described in further detail below, in some circumstances one or more streaming clients are randomly selected to increase the bitrate if the operation of DSS 120 is stable over a selected or predetermined period of time. The procedure then ends as indicated by done block 222.

FIG. 5 shows a flowchart 300 illustrating a procedure for determining whether the number of packets have been transmitted by DSS 120 (FIGS. 1, 3) but remain unprocessed by the streaming client 150 has increased or decreased. This determination is based on an estimate of the number of the transmission control protocol (TCP) video packets currently in transit and unprocessed. In operation 302, controller 126 (FIG. 3) determines a difference DIFF between a number of the TCP packets of the video data transmitted by transmit circuit 125 and a number of the TCP packets of the video data received by the receiver over a predetermined interval.

The number of the TCP packets of the streaming multimedia data received by the receiver is obtained from the receiver, preferably as a Real-time Transport Control Protocol (RTCP) receiver report packet periodically sent by the receiver and received by receive circuit 128. The number of the TCP packets of the video data transmitted by video conferencing system 100 is obtained from video conferencing system 100. In a preferred embodiment, the RTCP reporting interval is two seconds, and the numbers of packets are counted starting with an initialization event, such as the start of the current video conferencing session.

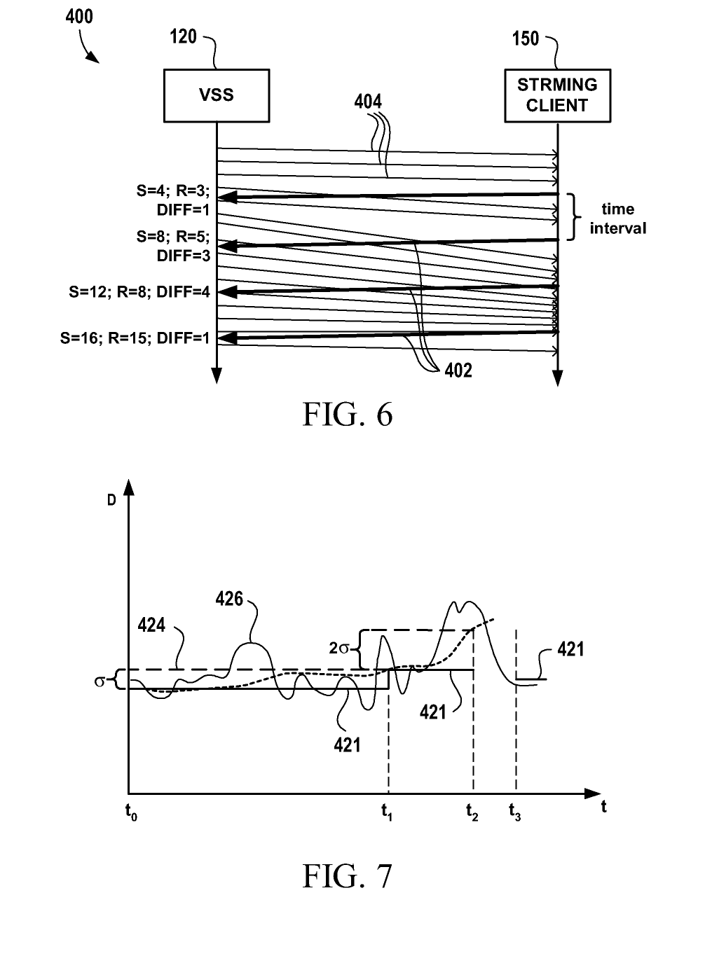

FIG. 6 shows an exemplary transaction between DSS 120 and a streaming client 150. DSS 120 continually transmits data packets 404 containing streaming multimedia data such as video data to streaming client 150. Periodically, e.g., every 2 seconds, streaming client 150 transmits reporting packets 402 back to DSS 120. Each reporting packet indicates the number of data packets 404 that have been received. DSS 120 subtracts the number of data packets received R from the number of data packets sent S to arrive at a difference value DIFF. As will be appreciated, during periods of network congestion, increased delays in receiving and processing data packets will result in larger values for DIFF. It should be noted that FIG. 6 does not provide actual test data, and is only presented here for illustration purposes only. In an actual implementation, the number data packets of streaming data in each two-second interval can average around 30 packets.

Returning to FIG. 5, in operation 304, controller 126 (FIG. 3) estimates the number D of transmitted packets of the video data that are in transit over network 155. Preferably, the estimate D is calculated as the median of the previous 50 values of DIFF, although a different number of values of DIFF can be used, and instead of the median, the mean, the mode or some other function of the values of DIFF can be used. During initialization, an insufficient number of values of DIFF are available to calculate D. In one embodiment, the first value of DIFF is used until 7 values of DIFF have been calculated. Thereafter, the median of all of the values of DIFF is used until 50 values of DIFF have been calculated, after which a sliding window of the 50 most recent values of DIFF is used, as described above. If network 155 (FIG. 3) is slow, the first few estimates of D might be too large. For example, the initial video bit rate may be much greater than the average bit rate for network 155. Therefore, in one embodiment, the initial video bit rate is initially limited based on the size S of the average packet of video data transmitted by video conferencing system 100. In one embodiment, if the average packet size exceeds K bits, then the bit rate is decreased by K/DS until DS<K, where K=40,000. Of course, other values for K can be used.

The procedure illustrated by flowchart 300 benefits from the stability of the value of D. Therefore, in a preferred embodiment, when a new value of D is calculated, it is compared to the previous value of D. If the new value of D falls inside an estimate window surrounding the previous value of D, then the new value of D is discarded, and the previous value of D is used. In one embodiment, the estimate window is D ± one standard deviation of DIFF. In this embodiment, the standard deviation of DIFF is computed as the median absolute deviation of the previous 50 values of DIFF, although other computation methods can be used.

In operation 306, the standard deviation SDev of the packets of video data in transit is estimated. In one embodiment, the standard deviation SDev is computed as the median absolute deviation of the previous 50 values of DIFF, although other computation methods can be used. During initialization, an insufficient number of values of DIFF are available. In this case, the standard deviation SDev is computed as the average of the highest and lowest values of DIFF until 7 samples of DIFF have been received, although other computation methods can be used. Thereafter, the standard deviation SDev may be computed as described above.

A plurality of threshold values is determined based on DIFF and D. Furthermore, a counter I is maintained for each threshold. In one embodiment, four thresholds are used, and counters I1, I2, I3, and I4 are maintained. In addition, a counter I5 may be used to count the number of receiver reports for which no video bit rate adjustments are made.

In operation 308, it is determined whether DIFF exceeds the sum D and two times SDev. If DIFF does exceed D+2SDev, then the procedure flows to operation 310, wherein controller 126 increments counter I1, and the procedure flows to operation 312. In operation 312, it is determined whether I1=3. In this case, DIFF>D+2SDev for three consecutive RTCP receiver reports, and the procedure flows to operation 314 wherein controller 126 identifies that there are an increased number of unprocessed packets. This information is used to determine the outcome of operation 208 of flowchart 200 in FIG. 4. If DIFF>D+2SDev, then the procedure flows to operation 314, otherwise, it jumps to operation 322.

In operation 314, the procedure pauses for a period of time to allow for any changes made to the bitrate in accordance with flowchart 200 of FIG. 4 to be reflected in the new data. In one embodiment, the pause is implemented by skipping a predetermined number of RTCP report packets, e.g., 2 RTCP reports. Then in operation 316, all of the counters I1, I2, I3, 14, and I5 are reset. The procedure then flows back to operation 302 described above.

If, in operation 308, DIFF≦D+2SDev, then the procedure flows to operation 320 wherein counter I1 is reset to zero to ensure that counter I1 counts only consecutive RTCP receiver reports where DIFF>D+2SDev. The procedure then flows to operation 322.

In operation 322, it is determined whether DIFF exceeds the sum of the value of D and the standard deviation SDev. If DIFF>D+SDev, then the procedure flows to operation 324 wherein controller 126 increments counter I2. The procedure then flows to operation 326 to determine whether I2=5. If I2=5, then DIFF>D+SDev for five consecutive RTCP receiver reports and the procedure flows to operation 314 as described above. If I2<>5, then the procedure jumps to operation 330.

If at operation 322 DIFF≦D+SDev, the procedure flows to operation 328 wherein counter I2 is reset to zero to ensure that counter I2 counts only consecutive RTCP receiver reports where DIFF>D+SDev. The procedure then flows to operation 330.

In operation 330, it is determined whether DIFF exceeds the value of D. If DIFF>D, then the procedure flows to operation 332 wherein controller 126 increments counter I3. The procedure then flows to operation 334 wherein it is determined whether I3=9. If I3=9, then DIFF>D for nine consecutive RTCP receiver reports and the procedure flows to operation 314 as described above. If I3 <>9, then the procedure jumps to operation 338.

If, at operation 330, DIFF≦D, the procedure flows to operation 336 wherein counter I3 is reset to zero to ensure that counter I3 counts only consecutive RTCP receiver reports where DIFF>D. The procedure then flows to operation 338.

In operation 338, it is determined whether DIFF is less than the value of D. If DIFF<D, then the procedure flows to operation 340 wherein controller 126 increments counter I4. The procedure then flows to operation 342 to determine whether I4=6, meaning DIFF<D for six consecutive RTCP receiver reports. If I4=6, then DIFF<D for six consecutive RTCP receiver reports and the procedure flows to operation 344 to indicate a reduced number of unprocessed packets. If, in operation 342, I4<>6, then the procedure jumps to operation 348.

In operation 344, the indication that there are a reduced number of unprocessed packets is used in flowchart 200 (FIG. 4) to determine the outcome of operation 212. From operation 344, the procedure flows to operation 316 which skips two RTCP reports and resets counters as previously described.

If, at operation 338, DIFF>D, then the procedure flows to operation 346 wherein counter I4 is reset to zero to ensure that counter I4 counts only consecutive RTCP receiver reports where DIFF<D. The procedure then flows to operation 348.

In operation 348, I5 is incremented. At this state, the number of unprocessed packets has neither increased nor decreased significantly. For example, DIFF may be fluctuating from less than D to greater than D, generally indicating stable operation. To ensure that the bitrate does not stabilize at an unnecessarily low value, the counter I5 is used to determine whether the number of unprocessed packets has remained stable for 16 consecutive values of DIFF (that is, for J RTCP receiver report packets). In operation 350, it is determined whether I5=16. If I5=16, then the procedure flows to operation 344 which is described above. Otherwise, the procedure returns to operation 302. It should be noted that other threshold values of each of the counters I1 through I5 may be used.

FIG. 7 shows an exemplary graph 420 that illustrates an exemplary operation of flowchart 300 described above. Graph 420 illustrates the value of D plotted on the vertical axis as it changes with respect to time, plotted on the horizontal axis. At t₀, the procedure initializes with an initial value of D. New D-values 422 are calculated based on a sliding window of the previous 50 values. However, the new D-values 422 are discarded until the new D-values exceeds a standard deviation 424 from D. At time t₁, the new D-value 422 exceeds the standard deviation 424 from D and D jumps to the new value. In the mean time the value DIFF 426 is continuously calculated and compared with D. When DIFF 426 exceeds D by two standard deviations 428 for 3 consecutive packets, then an increased number of unprocessed packets is identified. Referring to flowchart 300 of FIG. 5, a path defined by operations 308, 310, 312, and 314 is followed. Referring to FIG. 4, an increased number of unprocessed packets in operation 208 leads to a reduction in the bitrate of the data stream in operation 210. Referring back to FIG. 7, at time t₂, the DIFF value 426 exceeds D by two standard deviations for over 3 cycles, and results in a reduced bitrate. The procedure illustrated by flowchart 300 in FIG. 5 pauses briefly at time t₂ and resumes with a new D at time t₃. It should be noted that the data represented in FIG. 7 does not reflect any actual test data and is presented for illustration purposes only. An advantage of this algorithm is that it accounts for the processing power of the streaming client. If the streaming client is using a slow personal computer, then the number of outstanding packets would increase and the bitrate would correspondingly decrease.

As mentioned previously, DSS server 120 (FIGS. 1, 3) may be required to stream data to many streaming clients and therefore, due to processor and bandwidth constrains, categorizes each streaming client in one of a plurality of categories, depending on each streaming client's ability to receive and process the data. Flowchart 200 (FIG. 4) utilizes the process of flowchart 300 (FIG. 5) to identify network congestion requiring that the bitrate supplied to the streaming clients be reduced into the next lower category.

Increasing bitrate requires ensuring not only that there is a reduced number of unprocessed packets, but also that there is sufficient bandwidth availability to accommodate the increased bitrate. Because all streaming clients 150 must be categorized in a defined number of categories, e.g., 3 categories, according to their capability to receive and process streaming data, DSS is not able to slowly increase bitrates by incremental amounts individually for each streaming client, as described in related U.S. patent application Ser. No. 11/051,674, which is directed to streaming media from conference server 110 to conference participants 130 (FIGS. 1, 3). Therefore, according to one embodiment, a mechanism is provided for identifying whether there is sufficient available bandwidth in a particular channel to accommodate the data stream at the next higher bitrate.

FIG. 8 shows a flowchart 450 illustrating a procedure for measuring a relative measurement of network bandwidth using inter-frame packet timings. The procedure begins as indicated by start block 452 and flows to operation 454 wherein a fake video packet is created. The measurement technique herein described uses two packets of similar sizes transmitted one after the other with a predetermined or known time interval therebetween. In one embodiment, the predetermined time interval may be five milliseconds. Unfortunately, there are not always multiple packets of the appropriate size provided in a data stream. For example, when the data stream represents video data, there may be little motion in the video such that only one packet is sent for each frame. Even when there is some motion, the video packets sent are often small and travel across the network in one combined network packet. To solve this, a fake video packet is injected into the stream. The fake packet is of a size and is delayed slightly so that it will not combine with the previous video packet. The fake packet also includes the sequence number of the previous data packet, e.g., video packet, so that the receipt order can be verified. Thus, in operation 456, a pair of timing packets is transmitted. In one embodiment, the pair of timing packets includes one of the video packets selected to be of appropriate size and the fake video packet. In other embodiments, the timing packets may also include two fake packets or two video packets, provided they are appropriately sized and temporally spaced so that they will not combine into a single network packet as it is transmitted through the network.

FIG. 9 shows an exemplary transaction between DSS 120 and a streaming client 150. In this example two pairs of timing packets, 482A and 482B are transmitted from DSS 120 to streaming client 150. Each pair of timing packets includes a video packet 486 containing video data and a fake packet 488 generated as described above in operation 454. When streaming client 150 receives the timing packet it calculates the time interval Δt that elapsed from the time the first packet of each timing packet pair was received to the time that the second packet of the pair of timing packets. Thus, a report 484A, 484B is sent back from streaming client for each pair of timing packets received, the report containing a value representing Δt. To recognize a timing packet that is received out of order, the fake timing packet also includes the sequence number of the previous video packet stamped into it. If the previous packet received by streaming client 150 does not have the same sequence number, then the packet is not in the correct order and the Δt value is not calculated. In one embodiment, an error packet is returned to DSS 120 indicating that the packet was received out of order.

Returning to FIG. 8, after DSS 120 transmits the timing packets, in operation 456, the timing report is received from streaming client 150 in operation 458. Then, in operation 460, a least squares regression calculation is performed on the Δt values received to identify a slope of a line that best fits the Δt values. The slope is estimated for a line that is plotted on a graph having the Δt values plotted on a vertical axis and time of receipt on a horizontal axis. It should be noted that an actual plot is not necessarily created; the slope of the best-fit line is calculated abstractly using available data and a known least-squares regression algorithm. If the slope of the best-fit line is positive, that means that the Δt values are increasing overall and network bandwidth is restricted. If the slope of the best-fit line is negative, that means that the Δt values are decreasing overall and that network bandwidth is increased. In one embodiment, the Δt values collected during the previous ten seconds are used in the least squares regression to identify the slope. Once the slope is calculated, the procedure flows to operation 462.

In operation 462, it is determined whether the slope of the best-fit line is negative. If the slope is negative, then the procedure flows to operation 464 in which it is determined that additional bandwidth is available. This determination is used in operation 214 of the procedure illustrated by flowchart 200 in FIG. 4. If, in operation 462, it is determined that the slope is not negative, e.g., it is positive or flat, (zero), then the procedure flows to operation 466 wherein it is determined that additional bandwidth is not available. This determination is also used in operation 214 (FIG. 4) as described above. The procedure in either case ends as indicated by done block 468.

The algorithm described above with reference to FIGS. 8 and 9 do not account for the processing capability of the client, i.e., the streaming client. Therefore, the procedure described above with reference to FIG. 4 requires both available bandwidth as described above with respect to FIGS. 8 and 9 as well as a reduced number of processed packets as described above with reference to FIGS. 5-7, since that procedure does account for local processing power of the streaming client.

Since the measurements are only an estimate and the network conditions are always changing, the number of bitrate increases may be limited. In one embodiment, the rate at which a connection can be raised is equal to two minutes divided by the number of levels from the highest bitrate level. Thus, if a streaming client is dropped from a highest bitrate to a second highest bitrate level, then an increase can happen 2 mins./2nd level=1 increase per minute. If a streaming client is dropped from a highest bitrate to a third highest bitrate, then the increase is 2 mins/3rd lvl=1 increase every 40 seconds.

In one embodiment, the number of streaming clients connected to the DSS that can increase may be limited over a selected interval of time. For example, the number of streaming client that can be increased may be limited to one every five seconds. This allows each client to increase its bitrate and the network to have a short time to stabilize, and up to 12 streaming client to increase their bitrate every minute.

In addition, an embodiment may include a burst detection routine to reduce the impact of data bursts. For example, when the streaming data includes video data, an I-frame may be periodically transmitted when the video includes significant motion. As generally known in the art of video compression, an I-frame contains sufficient information to construct a complete video frame without relying on data previously transmitted for previous video frames. As such, I-frames are significantly larger in terms of data requirements than typical video frames. When such a burst occurs, controller 126 can reduce the bitrate in each stream by half or cause a lower bitrate data stream to be selected for each connected client, and maintain that value for 3 RTCP receiver report packets before resuming normal bitrates.

Occasionally, it is possible that the network stabilizes at a bitrate that is not optimal. The algorithm may behave as though the network is optimized, but in actuality, the bitrate can be increased. To account for this, in one embodiment, when there has not been many network adjustments for a period of time, a connection to one of the streaming clients is randomly picked and switched to a data stream having the next highest bitrate. As long as this is not performed too often, it may help each connection to get to its optimum bitrate level.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated. Further, the manipulations performed are often referred to in terms such as producing, identifying, determining, or comparing.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

Embodiments of the present invention can be processed on a single computer, or using multiple computers or computer components which are interconnected. A computer, as used herein, shall include a standalone computer system having its own processor(s), its own memory, and its own storage, or a distributed computing system, which provides computer resources to a networked terminal. In some distributed computing systems, users of a computer system may actually be accessing component parts that are shared among a number of users. The users can therefore access a virtual computer over a network, which will appear to the user as a single computer customized and dedicated for a single user.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for streaming data to a client, the method comprising a plurality of operations comprising:
transmitting a data stream over a computer network for receipt by a client, the data stream being selected from a plurality of data streams, each of the plurality of data streams having a different bitrate; the data stream being transmitted in the form of a series of data packets;
transmitting a pair of timing packets for receipt by a client, the timing packets comprising a first packet and a second packet, the second packet being transmitted after the first packet with a known delay;
receiving a plurality of reporting packets, the reporting packets each including a At value representative of the length of time that elapsed between a time of receipt of the first packet and a time of receipt of the second packet of a corresponding pair of timing packets;
determining that additional bandwidth is available when the Δt values decrease over time; and
selecting a new data stream for receipt by the client when the additional bandwidth is determined to be available, the new data stream having a higher bitrate than the data stream.

2. The method of claim 1, wherein the first packet and second packet are transmitted less than five milliseconds apart from each other, but are separated in time sufficiently so that the first and second packets are not likely to be combined into a common network packet.

3. The method of claim 1, wherein the first packet is one of the data packets and contains data for streaming media, the streaming media including at least one of an audio stream and a video stream.

4. The method of claim 3, wherein the second packet is a fake packet that does not include data for streaming media.

5. The method of claim 3, wherein the second packet comprises a sequence number of the first packet so that the client can confirm an order of receipt of the timing packets.

6. The method of claim 1, further comprising estimating a slope of a line that best fits the plurality of received Δt values when the line is plotted on a graph having the At values plotted on a vertical axis and time of receipt on a horizontal axis, the determining that additional bandwidth is available comprising determining that a slope of the line is negative.

7. The method of claim 6, the estimating comprises performing a least squares regression calculation to determine the slope of the line.

8. The method of claim 1, further comprising:
determining whether the client has an increased number of unprocessed packets; and
selecting a data stream having a lower bitrate then a current data stream being transmitted when the client has an increased number of unprocessed packets.

9. The method of claim 8, wherein the determining of whether the client has an increased number of unprocessed packets comprises comparing a number of packets received by the client with a number of packets transmitted from the server, the number of packets received being reported to the server in a reporting packet.

10. The method of claim 8, wherein the new data stream having a higher bitrate is only selected when the additional bandwidth is determined to be available and the client has a decreased number of unprocessed packets.

11. The method of claim 1, wherein each of the operations is performed by a computer system in response to program instructions embodied in a machine readable medium.

12. A server for streaming data comprising:
a media codec configured to receive a high bitrate data stream, the data stream representing media content, the media codec generating at least one lower bitrate data stream, each of the lower bitrate data streams representing the media content;
a packetizer for encapsulating the high bitrate data stream and each of the lower bitrate data streams into network packets; and
a transmit circuit, the transmit circuit being configured to transmit current one of the data streams over a network for receipt by a client, the current one of the data streams being transmitted in the form of a plurality of network packets;
a receive circuit, the receive circuit being configured to receive communications from the client; and
a controller, the controller being configured to cause the transmit circuit to periodically transmit a pair of timing packets for receipt by the client, each of the pair of timing packets comprising a first packet and a second packet, the second packet being transmitted after the first packet with a known delay, the controller being in communication with the receive circuit, the controller being configured to receive a report from the client in response to each pair of timing packets, each of the reports including a Δt value representative of the length of time that elapsed between receipt of the first packet and receipt of the second packet of the pair of timing packets, the controller further being configured to determine that additional bandwidth is available when the Δt values decrease, and to cause the transmit circuit to transmit a higher bitrate one of the data streams for receipt by the client than the than the current one of the data streams when the additional bandwidth is determined to be available.

13. The server of claim 12, wherein the first packet and second packet are caused to be transmitted less than five milliseconds apart from each other, and are separated in time sufficiently so that the first and second packets are not likely to be combined into a common network packet.

14. The server of claim 12, wherein the first packet is one of the data packets and contains data from the current one of the data streams, the data streams each including at least one of an audio stream and a video stream.

15. The server of claim 14, wherein the second packet is a fake packet that does not include data from one of the data streams.

16. The server of claim 14, wherein the second packet comprises a sequence number of the first packet so that the client can confirm an order of receipt of the pair of timing packets.

17. The server of claim 12, wherein the controller is further configured to estimate a slope of a line that best fits a plurality of the Δt values when the line is plotted on a graph having the Δt values plotted on a vertical axis and time of receipt on a horizontal axis, wherein the additional bandwidth is determined to be available when a slope the line is negative.

18. The server of claim 17, wherein the controller estimates the slope based on a least squares regression calculation.

19. The server of claim 12, wherein the controller is further configured to determine whether the client has an increased number of unprocessed packets, and to transmit a lower bitrate one of the data streams when the client has an increased number of unprocessed packets.

20. The server of claim 19, wherein the controller is configured to determine whether the client has an increased number of unprocessed packets by comparing a number of packets received by the client with a number of packets transmitted from the server, the number of packets received being reported to the server in a reporting packet.

21. The server of claim 19, wherein the controller only transmits the higher bitrate one of the data streams when the additional bandwidth is determined to be available and the client has a decreased number of unprocessed packets.

22. A method for adjusting a bitrate of streaming data being transmitted to a client, the method comprising:
transmitting a first one of plurality of data streams over a computer network for receipt by the client, each of the plurality of data streams containing streaming data representing a multimedia signal in the form of a plurality of data packets, each of the plurality of data streams having a different bitrate than others of the data streams;
monitoring a number of unprocessed ones of the data packets;
ceasing transmission of the first one of the plurality of data streams and transmitting a lower bitrate one of the plurality of data streams when the number of unprocessed data packets increases;
determining whether additional bandwidth is available; and
ceasing transmission of the lower bitrate data stream and initiating transmission of a higher bitrate one of the data streams when the number of unprocessed data packets reduces and the additional bandwidth is available.

23. The method of claim 22, wherein the number of unprocessed ones of the data packets is monitored by comparing a number of processed data packets as reported from the client to a number of the data packets transmitted.

24. The method of claim 23, wherein the additional bandwidth is determined to be available by:
periodically transmitting a pair of timing packets to a client, each of the timing packets comprising a first packet and a second packet, the second packet being transmitted after the first packet with a known delay;
receiving a plurality of reporting packets from the client, each of the reporting packets corresponding to one of the pairs of timing packets and including a Δt value representative of the length of time that elapsed between receipt by the client of the first packet and the second packet;
determining that additional bandwidth is available when the Δt values decrease over time.

25. The method of claim 22 wherein the streaming data is transmitted to a plurality of clients, each client receiving one of the data streams, the method further comprising:
limiting a number of clients that are changed from a lower bitrate data stream to a higher bitrate data stream over a selected interval of time.

26. The method of claim 22, further comprising:
ceasing transmission of a current data stream and transmitting a lower bitrate data stream for a limited period of time when a burst of streaming data is detected, the lower bitrate data stream having a lower bitrate than the current data stream.
